(19) United States
(12) Patent Application Publication
(10) Pub. No.: US 2003/0055899 A1
(43) Pub. Date: Mar. 20, 2003

(54) Method and system for setting up conference call

(75) Inventors: Manfred Burger, Miesbach (DE); Thomas Lederer, Muenchen (DE); Hubertus Hohl, Haar (DE)

Correspondence Address: STAAS & HALSEY LLP, 700 11TH STREET, NW, SUITE 500, WASHINGTON, DC, 20001, US

(73) Assignee: Siemens AG.

(21) Appl. No.: 10/207,394

(22) Filed: Jul. 30, 2002

(30) Foreign Application Priority Data
Jul. 30, 2001 (DE) 101 372 26.4

(51) Int. Cl. G06F 15/16; H04L 12/16; H04Q 11/00

(52) U.S. Cl. 709/205; 370/260

(57) ABSTRACT

Trigger information triggers retrieval of stored communication addresses which identify conferee terminals. Connections are then setup to terminals identified by retrieved communication addresses, respectively and the terminals are added to the conference call.

### CROSS REFERENCE TO RELATED APPLICATIONS

This application is based on and hereby claims priority to German Application No. 101 372 26.4 filed on Jul. 30, 2001, the contents of which are hereby incorporated by reference.

### BACKGROUND OF THE INVENTION

Contemporary communication systems generally support not only two-point connections but also conference calls, i.e. connections between three or more subscribers. Such conference calls can be set up, by way of example, between terminals for voice, video and/or multimedia communication or between personal computers in order to implement voice, video and/or multimedia conferences, for example.

Conventionally, a conference call is setup by one of the conferees, the “conference manager”, by successively calling and adding the other conferees or by a “conference server”. When a conference is set up by a conference manager, indirect and direct method variants are common:

In the case of indirect conference setup, the conference manager calls the first conferee, puts the connection which has been set up into a hold state, makes a consultation call to the next conferee, includes the two in the conference call and possibly puts them into a hold state in order to call a further conferee. These method steps are repeated until all the conferees have been added to the conference call.

In the case of direct conference setup, it is possible—provided that this is supported by the communication system in question—to call a further conferee directly from an active call or from an active conference call without the need to put the conference call into a hold state beforehand. As soon as a conferee called in this manner accepts the call, he is immediately incorporated into the conference call.

Both in the case of direct conference setup and in the case of indirect conference setup, conventionally the conferees need to be called individually and in succession by the conference manager. Particularly for conferences involving a large number of conferees, however, such conference setup is very time consuming and susceptible to operating errors.

When a conference is set up using a conference server, the conferees dial up the conference server individually and are added to the conference call by the conference server. However, this type of conference setup requires the conferees to agree on a time and on the participants in the conference beforehand. This is also generally very time consuming.

### SUMMARY OF THE INVENTION

It is an object of the present invention to simplify setting up a conference call.

The invention largely automates setup of a conference call, e.g. for voice, video and/or multimedia communication. This has the advantage that a conference call can be set up much more quickly and flexibly than in the prior art, which significantly extends the range of application of conference calls. Retrieval of already stored communication addresses for identifying conferees' terminals reduces input and operating errors as compared with manual input of communication addresses.

The terminals between which the conference call is set up can be, by way of example, terminal equipment, personal computers, clients and/or user applications, in each case for voice, video and/or multimedia communication. The communication addresses for identifying the terminals can be implemented, by way of example, by call numbers, conferees' names, Internet protocol addresses and/or “URLs”. Conference setup is triggered by trigger information, for example in the form of a trigger signal or a trigger report.

The inventive conference setup device can be implemented in the form of a module, an application or a client locally in one or more terminals or else centrally in a central server. Local implementation is advantageous inasmuch as it permits individual configuration of the conference setup device on every terminal equipped in this manner. In comparison with a conventional conference server, another advantage of the invention is that no additional costs are incurred for use of a conference service, and that no additional resource reservation is necessary. Another advantage of the invention is that its implementation requires no changes to an existing switching technology. The invention can thus easily be incorporated into existing communication systems.

In accordance with one advantageous development of the invention, it is possible for a set of communication addresses to be stored in association with a conference identifier. The trigger information can then trigger detection of a conference identifier in order thus to trigger retrieval of those communication addresses which are associated with the detected conference identifier. In this way, a plurality of sets of communication addresses respectively representing various groups of conferees can respectively be assigned to a unique conference identifier. According to the detected conference identifier, the trigger information can then selectively trigger a conference call to a group of conferees which has been selected by the conference identifier.

In accordance with one advantageous embodiment of the invention, the trigger information, possibly with a conference identifier, can be generated by user input on a terminal. To this end, the conference setup device can have a user interface to a terminal. Generation of the trigger information and hence triggering of conference setup can be prompted, by way of example, simply by pressing a single key or clicking a mouse on a user terminal. By way of example, a conference group identified by a conference identifier can be assigned to a one-touch dialing key or to a trigger area on a graphical user interface in order to generate trigger information with this conference identifier at the touch of a key or the click of a mouse.

In addition, conferences which have already been held can be stored in a call journal with the communication addresses which identify the conferees in question. By selecting such a conference stored in the call journal, it is possible to trigger setup of a conference with the same conferees, preferably by pressing a key or clicking a mouse. In addition, a conference call can be set up by first selecting the participants therein from one or more electronic address books, preferably under menu guidance, and storing the relevant communication addresses. Trigger information is then generated which triggers retrieval of the stored communication addresses and triggers setup of the conference.

Alternatively, the trigger information can also be generated by an appointments diary application. In this way, a conference call can be initiated by the appointments diary application, e.g. at a prescribed time corresponding to a conference appointment stored in the appointments diary application. A conference entry in the appointments diary application contains not only the conference appointment but preferably also details which the conference setup device can use to identify the conferees or their terminals. Preferably, the communication addresses of the conferees are stored in the appointments diary application for retrieval by the conference setup device.

In accordance with one preferred development of the invention, setup of a connection to a respective terminal can involve retrieving advisory information about the conference setup and outputting it to this terminal. In this context, the advisory information can be output both before completion of connection setup, e.g. for the purpose of display on a display or on a graphical user interface on the terminal in question, or after completion of connection setup, e.g. in the form of spoken advice. Preferably, the advisory information can inform the conferee in question that he is being added to a conference call.

In addition, for the case in which the conference call is initiated by a terminal, conference setup can involve outputting advisory information about the conference setup to this initiating terminal. In this way, a conferee initiating the conference can be informed about the progress of conference setup through advisory information in the form of status reports.

Furthermore, the addition of a respective terminal to the conference call can involve outputting advisory information, e.g. specific addition information, to already added terminals.

Respective advisory information which is to be output can be retrieved by the conference setup device from a memory, e.g. in the form of stored audio, and/or can be generated at least in part by a voice synthesis device or an audio signal transmitter, for example. Advisory information can also be formed by combining prescribed audio modules. The advisory information can be generated, in particular, on the basis of the conference status.

The advisory information which is output to a terminal can be displayed on a display or on a graphical user interface on the terminal in question. In addition, the advisory information can be output in spoken form, e.g. in the form of spoken advice, on the terminal in question.

In accordance with one preferred embodiment of the invention, the connections to the terminals identified by the retrieved communication addresses can be set up in parallel. Parallel connection setup significantly reduces the time required for setting up a conference.

In accordance with another advantageous development of the invention, if connection setup to a conferee terminal fails, at least one fresh connection attempt can be made at a prescribed interval of time. Preferably, a plurality of connection attempts can be made at regular intervals of time. In addition, if connection setup to a conferee terminal fails, a call-back call can also be initiated for this terminal. Preferably, if connection setup fails, a report in the form of advisory information can be output to a respective terminal associated with one or more conferees.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a communication system with a plurality of terminals coupled to a communication network, and

FIG. 2 is a block diagram of an inventive conference setup device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

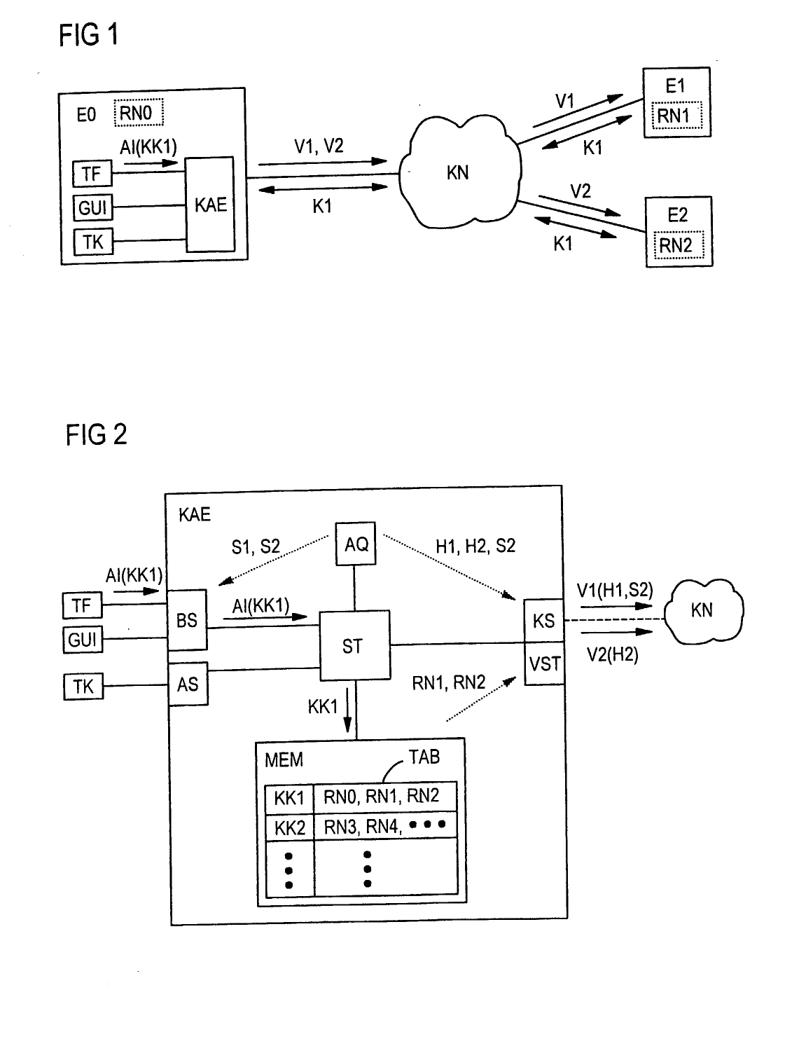

FIG. 1 is a block diagram of a communication system with three terminals E0, E1 and E2 coupled to a communication network KN. In this context, the communication network KN can be a circuit-switched communication network or a packet-switched communication network, such as a local area network or a wide area network. In particular, the communication network KN can be implemented by an Internet protocol based network), preferably on the basis of ITU-T recommendations H.323 and H.450. The terminals E0, E1 and E2 can be any terminals for voice, video and/or multimedia communication, such as telephones or computer based VoIP applications or VoIP clients. Each terminal E0, E1 and E2 has an associated call number RN0, RN1 and RN2 as a communication address, and this call number can be used to address or reach the terminal in question via the communication network KN. The respective association between a call number RN0, RN1 and RN2 and a respective terminal is indicated in FIG. 1 by dotted rectangles.

The text below considers setup, initiated from the terminal E0, of a conference call between the terminals E0, E1 and E2. A user of the terminal E0 who initiates the conference call is subsequently referred to as the conference manager.

As functional components, the terminal E0 has an inventive conference setup device KAE, which can be in the form of a module, software application or client, for example, a keypad TF, a graphical user interface GUI, and an appointments diary application TK. The keypad TF, the graphical user interface GUI and the appointments diary application TK each have an interface to the conference setup device KAE.

Setup of the conference call can be initiated both by the conference manager, using the keypad TF or using the graphical user interface GUI, and automatically by the appointments diary application TK.

The conference manager can initiate the conference call in various ways. By way of example, the conference manager can enter one or more groups of conferees, or their call numbers, on the terminal E0 in advance and can assign them to a respective one-touch dialing key on the keypad TF or to a selection area in the user interface GUI. In this case, a conference call can be triggered between the respectively assigned conferees simply by pressing the one-touch dialing key or by clicking the mouse on the selection area. In accordance with one method variant, conferences which have already been held can respectively be stored as an entry in a call journal. By selecting such an entry, e.g. by pressing a key on the keypad TF or by clicking the mouse in the graphical user interface GUI, it is then a simple matter to prompt a fresh conference call between participants in a conference which has already been held. In addition, the conference manager can also select conferees from another electronic address memory, preferably under menu guidance, and can then trigger setup of a conference call between the selected conferees, e.g. by pressing a key or clicking the mouse.

The appointments diary application TK can trigger the conference call automatically at a prescribed time derived, by way of example, from a conference appointment stored in the appointments diary application TK. Provided that the required conferees have also been entered in the appointments diary application TK together with the conference appointment, the conference setup device KAE can use this entry to identify the conferees and their call numbers. If the conferees' call numbers have not been entered in the appointments diary application, the conference setup device KAE can ascertain these call numbers automatically from one or more address menus.

For the present exemplary embodiment, it is assumed that the conference manager triggers a conference call K1 by pressing a single key on the keypad TF. Pressing the key causes a single trigger information item A1 to be transmitted from the keypad TF to the conference setup device KAE. The trigger information A1 comprises a conference identifier KK1 having an associated prescribed group of conferees or their terminals, in this case E0, E1 and E2. In the conference setup device KAE, retrieval of call numbers, in this case RN0, RN1 and RN2, identifying the terminals E0, E1 and E2 is triggered by the trigger information A1. The conference setup device KAE then prompts setup of a two-point connection V1 to the terminal E1 identified by the call number RN1 and of a two-point connection V2 to the terminal E2 identified by the call number RN2, in each case via the communication network KN. When the two-point connections V1 and V2 have been set up, the terminals E1 and E2 together with the terminal E0 are connected together via the communication network KN to form a conference call K1. In this context, a respective terminal E1 or E2 can be added to the conference call K1 either immediately upon acceptance of the two-point connection V1 or V2 by the subscriber in question or only after receipt of advisory information about the conference setup.

The two-point connections V1 and V2 can be set up on the basis of different method variants which can be selected by the conference manager:

1. The two-point connections V1 and V2 can be set up in parallel to the terminals, in this case E1 and E2, of all other conferees, provided that this is supported by the terminal E0. This significantly reduces the time required for setting up the conference call K1. Such parallel setup of two-point connections for the purpose of conference setup is not possible in the case of previously known conference setup methods.

2. The two-point connections V1 and V2 can be set up in a prescribable order. Preferably, the order can be configured by the conference manager before the conference call is initiated.

3. The two-point connections V1 and V2 can be set up in succession, with each connection setup respectively needing to be confirmed by the conference manager following a consultation call. This allows individual conferees to be skipped, for example.

When the conference call K1 has been set up completely, connection of the conference call K1 can be indicated to the conference manager by an audible signal, for example.

If setup of the two-point connection V1 or V2 to the terminal E1 or E2 fails, e.g. because the conferee in question cannot be reached, or the terminal E1 or E2 in question is in the busy state, different method variants can be provided:

1. The conference setup device KAE can prompt activation of a call-back call for the terminal E1 or E2 in question. As soon as the terminal E1 or E2 in question becomes free, the conference setup device KAE can make a fresh attempt to add the terminal E1 or E2 in question to the conference call K1.

2. The conference setup device KAE can prompt fresh dialing of the terminal E1 or E2 in question at regular intervals of time. In the meantime, other conferees' terminals can be dialed up or added in this context.

3. The conference setup device KAE can inform the conference manager about the failure of connection setup to a terminal and can immediately continue with dialing up or adding another terminal.

The conference setup device KAE is preferably designed such that the selection of a suitable method variant is configurable, and in particular is configurable on the basis of the situation.

Preferably, the conference manager is informed by the conference setup device KAE about a conference status and/or about conferees who cannot be reached following or during setup of the conference call K1.

FIG. 2 is a block diagram of the inventive conference setup device KAE. As functional components, the conference setup device KAE has a central control device ST, a conference memory device MEM for storing and detecting conferees' communication addresses, an audio source AQ, a user interface BS to the keypad TF and to the graphical user interface GUI, an application interface AS to the appointments diary application TK, a communication interface KS and a connection controller VST connected to the latter. The communication interface KS couples the conference setup device KAE to a communication platform on the terminal E0, and the conference setup device KAE can use this communication platform—as indicated by a dashed line—to access the communication network KN. The connection controller VST can prompt setup of connections, in this case V1 and V2, via the communication network KN and can prompt linking of connections to form a conference call, in this case K1. The connection controller VST, the communication interface KS, the conference memory device MEM, the audio source AQ, the user interface BS and the application interface AS are each coupled to the central control device ST.

The conference memory device MEM contains an address table TAB which stores sets of call numbers or in association with a respective conference identifier KK1 or KK2. Each set of call numbers in the address table TAB identifies the terminals of all the participants in a respective conference. By way of example, the call numbers RN0, RN1, RN2 associated with the conference identifier KK1 identify the terminals E0, E1 and E2 of the participants in the conference K1.

To trigger the conference call K1, the trigger information A1 with the conference identifier KK1 is transmitted from the keypad TF to the central control device ST via the user interface BS and is detected by the central control device ST. The central control device ST performs the function of a trigger unit by recognizing the trigger information A1 and triggering setup of the conference call K1. This involves extracting the conference identifier KK1 from the trigger information A1 and transmitting it to the conference memory device MEM. Transmission of the conference identifier KK1 prompts retrieval of the call numbers RN0, RN1 and RN2 associated with this conference identifier KK1 in the address table TAB. This involves central control device ST acting as an address detection unit to establish that the call number RN0 is associated with the terminal E0 from which the conference call K1 is triggered. The remaining call numbers RN1 and RN2 associated with the conference identifier KK1 are then transmitted to the connection controller VST, as indicated by a dotted arrow. The connection controller VST then prompts setup of a two-point connection V1 to the terminal E1 identified by the transmitted call number RN1 and of a two-point connection V2 to the terminal E2 identified by the transmitted call number RN2.

In the course of connection setup to the conferees, each conferee is informed about the conference setup by virtue of advisory information H1 and H2 being transmitted. In the present exemplary embodiment, for this purpose, the audio source AQ retrieves or generates audible advisory information H1 and H2 and outputs it via the communication interface KS—as indicated by a dotted arrow. The advisory information H1 is transmitted to the terminal E1 via the two-point connection V1, and the advisory information H2 is transmitted to the terminal E2 via the two-point connection V2. The advisory information H1 and H2 can be generated by the audio source AQ, preferably in spoken form, for example by retrieving and playing stored audio, such as “You will shortly be part of a conference call. Please wait . . . ”, by producing status-dependent or context-dependent audio clips using voice synthesis and/or by assembling stored audio modules, such as “You will shortly be part of a conference call. Other participants are Mr. Müller and Ms. Meier. Please wait . . . ”. Alternatively or in addition, it is also possible to provide advisory information for display on a display and/or a graphical user interface on the called terminals, in this case E1 and E2.

Preferably, the addition of a conferee's terminal involves the already added conferees being informed about the addition by the conference setup device KAE using advisory information in the form of addition or status information. Such addition or status information can, by way of example, be an audible signal or spoken advice. While a conference which is to be set up is in a hold state, one of the advisory information items described above can be played in the conference on hold as an alternative or in addition to customary hold music. In addition, the conference setup device KAE can output advisory information about the status of the conference setup in the form of a report to the conference manager's terminal E0.

For the present exemplary embodiment, it is assumed that the two-point connection V1 to the terminal E1 is set up before the two-point connection V2 to the terminal E2, and consequently the terminal E1 is added to the conference K1 before the terminal E2. Accordingly, addition of the terminal E1 involves the control device ST prompting the audio source AQ to generate audible status or addition information S1 as advisory information and to output it to the terminal E0 via the user interface BS. Similarly, addition of the terminal E2 involves the control device ST prompting the audio source AQ to generate status or addition information S2 and to transmit it both via the user interface BS to the terminal E0 and via the communication interface KS to the already added terminal E1 within the scope of the two-point connection V1.

Alternatively or in addition, advisory information can also be generated and output for display on a graphical user interface associated with the conference manager or with the other conferees. This allows, by way of example, constant indication of who is currently involved in the conference call or who was not available. In addition, the conference setup device KAE can be configured particularly easily using a graphical user interface.

The invention has been described in detail with particular reference to preferred embodiments thereof and examples, but it will be understood that variations and modifications can be effected within the spirit and scope of the invention.

What is claimed is:

1. A method for setting up a conference call, comprising:
triggering retrieval of stored communication addresses identifying conferee terminals in response to trigger information;
setting up connections to terminals identified by the stored communication addresses, respectively, and
adding each of the terminals to the conference call.

2. The method as claimed in claim 1,
wherein a set of communication addresses is stored in association with a conference identifier, and
wherein said triggering in response to the trigger information triggers detection of a conference identifier and retrieval of the communication addresses associated with the conference identifier.

3. The method as claimed in claim 2, further comprising generating the trigger information by user input on a terminal.

4. The method as claimed in claim 3, wherein said setting up includes
retrieving advisory information about setup of the conference call; and
outputting the advisory information to the terminal.

5. The method as claimed in claim 2, further comprising generating the trigger information by an appointments diary application.

6. The method as claimed in claim 2,
further comprising initiating the conference call by a terminal, and
wherein said setting up includes outputting advisory information about setup of the conference call to the terminal.

7. The method as claimed in claim 6, wherein said adding of one of the terminals to the conference call includes outputting advisory information to already connected terminals.

8. The method as claimed in claim 7, further comprising displaying the advisory information on a display of the already connected terminals.

9. The method as claimed in claim 8, wherein said displaying uses a graphical user interface.

10. The method as claimed in claim 6, further comprising outputting the advisory information in spoken form to the already connected terminals.

11. The method as claimed in claim 2, wherein said setting up connects the terminals in parallel.

12. The method as claimed in claim 2, further comprising making at least one fresh connection attempt at a prescribed interval of time, if connection setup to a conferee terminal fails.

13. The method as claimed in claim 2, further comprising initiating a call-back call for a conferee terminal, if connection setup to the conferee terminal fails.

14. A conference setup device for setting up a conference call between conferee terminals, comprising:
a trigger unit to trigger conference setup when trigger information is received,
an address detection unit to retrieve stored communication addresses identifying the conferee terminals, when triggered by the trigger information; and
a connection controller to set up connections to the conferee terminals and to add the conferee terminals to the conference call.

15. The conference setup device as claimed in claim 14, further comprising a user interface, coupled to said trigger unit, for a user of one of the conferee terminals.

16. The conference setup device as claimed in claim 15, further comprising an application interface, coupled to said trigger unit, for an appointments diary application.

17. The conference setup device as claimed in claim 16, further comprising an output unit to retrieve advisory information about setup of the conference call and to output the advisory information to at least one of the conferee terminals.

18. A terminal for setting up a conference call between conferee terminals, comprising:
a trigger unit to trigger conference setup when trigger information is received,
an address detection unit to retrieve stored communication addresses identifying the conferee terminals, when triggered by the trigger information; and
a connection controller to set up connections to the conferee terminals and to add the conferee terminals to the conference call.

19. The terminal as claimed in claim 18, further comprising an application interface, coupled to said trigger unit, for an appointments diary application.

20. The terminal as claimed in claim 19, further comprising an output unit to retrieve advisory information about setup of the conference call and to output the advisory information to at least one of the conferee terminals.
